(19) United States
(12) Patent Application Publication
(10) Pub. No.: US 2002/0050708 A1
(43) Pub. Date: May 2, 2002

(54) Cover mounted loose paper storage system

(76) Inventors: Miles Conklin, St. Louis, MO (US); Michael W. Lamming, O'Fallon, MO (US); James R. Schmidt, Chesterfield, MO (US); Debra Winzen, Chesterfield, MO (US)

Correspondence Address: Kirk A. Damman, Lewis, Rice & Fingersh, L.C., Ste 2000, 500 North Broadway, St. Louis, MO, 63102, US

(21) Appl. No.: 09/954,083

(22) Filed: Sep. 17, 2001

Related U.S. Application Data
(60) Provisional application No. 60/232,767, filed on Sep. 15, 2000.

(51) Int. Cl. B42D 1/00

(52) U.S. Cl. 281/15.1

(57) ABSTRACT

An organizer such as a binder, tablet cover or other protective cover, with a built in loose paper storage system independent of the holding mechanism for the sheets or objects included therein. The system allows for the storage of a reasonably large number of papers, and allows for organization of those loose papers in a manner which is generally similar to that of papers in the sheet holding mechanism. This system allows for easy organization of materials which are not adapted for use with the sheet holding mechanism while maintaining the standard functionality of the organizer for papers that are useable with the sheet holding mechanism.

### CROSS REFERENCE TO RELATED U.S. APPLICATIONS

This application claims priority to U.S. Provisional Patent Application Ser. No. 60/232,767 filed Sep. 15, 2000, the entire disclosure of which is herein incorporated by reference.

### BACKGROUND OF THE INVENTION

1. Field of the Invention

This disclosure relates to the field of storage or filing systems, particularly to binders or other organizers with loose paper storage systems attached to a cover.

2. Description of the Related Art

Paper and organized paper storage is a problem confronted by business people and students on a regular basis. One problem generally arises because there are two types of paper used in ordinary activities. There are papers configured to be held together and “bound” and there are loose papers which are not so configured. Papers configured to be held together often are used for blank paper (for instance upon which to take notes) or as certain prepared and bound books or handouts for presentation. In addition to this paper, however, arriving at a presentation, meeting, or class often involves acquiring loose paper, that are not designed to be stored in the holding mechanism of the organizer which the person has (although they may be attached together). The problems arise when papers configured to be held together are to be stored with papers which are loose. For instance, notes taken at a meeting and papers received at a meeting are often intended to be kept together (e.g. to provide a comprehensive record of what was discussed at a meeting). There is a need for organizers which can effectively carry and/or store both types of paper together in an organized manner.

Generally, storage or transportation of paper is accomplished through an organizer. Probably the most recognized paper organizer is the 3-ring binder which is a cover provided with a 3-ring element attached inside the binder cover for securing papers which have been punched with three holes corresponding to the location of the three rings. These types of organizers provide for secure storage of papers held on the ring element while simultaneously organizing these papers, if desired. Papers placed in three-ring binders are often organized by tabbed organizing pages which can be placed on the rings to separate the pages in a logical order, such as with letter or number references. These tabbed pages help to arrange the papers included within the binder rings into subgroups so that particular papers can be easily found. For instance, in the case of a student, a large binder could be subdivided into school subjects so that papers for history class can be found when the student goes to history, while papers for math can be easily found when the student is in math.

These organizers provide limited storage and/or organization for papers which are desired to be placed into them but are not punched, however. It is common in binders to provide pockets on the inside of the cover to provide temporary storage of loose papers, however, the capacity of such pockets is limited because they are generally manufactured from a thin sheet of material placed in parallel with the cover and attached thereto to form a thin opening into which papers can be slid. These pockets generally only hold about 5-7 pages of paper before they begin to deform or appear unsightly or overstuffed. This is often insufficient for the number of pages to be stored.

Another problem with these pockets is that they cannot organize papers like the dividers can on the rings, leading to the loose papers being unsorted. Because of these problems, the binder often has to be used in conjunction with a different organizer specifically designed to hold and/or organize papers that are not adapted to be placed on the holding mechanism of the binder (loose papers). The use of two separate organizers, however, provides new problems. For instance, the two items can become separated leading to a loss of information or the two items may not be adapted for similar storage. For instance, the binder may be adapted for storage on a bookshelf, while a file for papers which are not three-hole punched may be best stored in a file cabinet.

Although methods for allowing papers to be placed in the binders exist (three hole punches), often the papers received are not suitable for such punching. For instance, information may be lost by having to punch holes through text, the papers may be bound or already configured for a different type of mechanism making them difficult to punch, or items other than papers (e.g. computer media) may be provided which would be destroyed by hole punching. Further, the person using the organizer may not have time or desire to punch the loose papers.

The binder is not the only type of organizer used to keep track of papers. Instead of using binder rings, often times papers are provided in a fixed media which does not allow the addition of pages to its sheet holding mechanism. This could be, for instance, a spiral notebook or a writing tablet. These types of paper sources are often placed within an organizer to make them more attractive and/or to improve their resiliency. Again, however, these organizers fail to provide sufficient storage for papers which are not included within the holding mechanism of the pad and cannot organize those loose papers. In this case, the problem is particularly acute because it is generally impossible to add loose papers (e.g. there is no “spiral punch”) to a tablet or spiral notebook so the organizer needs to provide all storage for papers not already in the holding mechanism. To attempt to provide such storage, the organizer cover may include a single pocket (like those described above for binders) which, for those reasons discussed above, is insufficient to handle significant numbers of loose papers, and is inadequate for organizing those papers.

There is, therefore, a need in the art for an organizer which can provide for both a holding mechanism for holding papers or other objects prepared for attachment to that holding mechanism as well as a storage mechanism associated therewith which allows for organization of loose papers not prepared for placement in the holding mechanism.

### SUMMARY

Because of these, and other previously unknown problems in the art, disclosed herein is an organizer with a built in loose paper storage system independent of the holding mechanism. The system allows for the storage of a reasonably large number of papers, and allows for organization of those loose papers in a manner which is generally similar to that of papers in the sheet holding mechanism. This system allows for easy organization of materials which are not adapted for use with the sheet holding mechanism while maintaining the standard functionality of the organizer for papers that are useable with the sheet holding mechanism.

Herein is disclosed, amongst other things, an embodiment of an organizer comprising; an organizer cover including, a front cover and a back cover and having an inside, and an outside; a sheet holding mechanism designed to secure items thereto which have been prepared for placement on the sheet holding mechanism, the sheets holding mechanism being inside and attached to the organizer; and a loose paper storage system, attached to at least one of the front cover and the back cover and including a loose paper storage system cover, and at least one divider.

In an embodiment, the organizer comprises a binder. In an embodiment the sheet holding mechanism comprises a ring mechanism and may comprise a three-ring mechanism. In an embodiment the divider includes a tab, which may include an identifier.

In an embodiment the loose paper storage system further includes a securement mechanism which may pass over at least one of a top edge and a bottom edge of the loose paper storage system and/or may comprise an elastic band.

In another embodiment the loose paper storage system is attached to an edge of the front cover and/or to an edge of the back cover. In another embodiment at least one divider includes at least one specialized divider which may be configured to hold computer media.

In yet another embodiment, there is disclosed a method for constructing an organizer, the method comprising: providing a first sheet of material, the first sheet including a front cover, a rear cover, a loose paper storage system cover, and at least two hinges; providing a second sheet of material, the second sheet of material having at least two dividers and a channel separating them; providing a third sheet of material, the third sheet of material having at least two dividers and a channel separating them; placing the channel of the third sheet on the channel of the second sheet and attaching the channels to each other and to the first sheet; attaching to the first sheet a mechanism configured to hold an object; and deforming the first, second, and third sheets, into an organizer with all the dividers positioned between the front cover and the loose paper storage system cover, and the mechanism positioned inside the front cover and the rear cover.

In yet another embodiment, there is disclosed an organizer comprising: a cover including, a front cover and a back cover and having an inside, and an outside; a holding mechanism attached inside the cover for holding an object therein; and a loose paper storage system, attached to the inside of the cover on at least one of the front cover and the back cover and including a loose paper storage system cover, and at least one divider.

In a still further embodiment, the object includes a pad of bound paper which may be a spiral notebook or a tablet. In a still further embodiment, the divider includes a tab which may include an identifier. At least one divider may also include at least one specialized divider which may be configured to hold computer media.

In a still further embodiment the loose paper storage system further includes a securement mechanism which may comprise an elastic band. In a still further embodiment the loose paper storage system is attached to an edge of the front cover and/or the loose paper storage system is attached to an edge of the back cover.

In a still further embodiment the cover is configured to protect the object, and in yet another embodiment the object includes at least one of a cellular telephone, a Personal Digital Assistant (PDA), a laptop computer, and an electronic data pad.

### BRIEF DESCRIPTION OF THE FIGURES

FIG. 1 is a perspective view of an embodiment of a ring binder including a loose paper storage system on the interior of the front cover. FIG. 1 shows an inner view of the binder with the loose paper storage system closed.

FIG. 2 shows an embodiment of a ring binder including a loose paper storage system as viewed from the inside with the loose paper storage system closed.

FIG. 3 shows an embodiment of a portion of a ring binder cover including a loose paper storage system as viewed from the inside with the loose paper storage system open and showing how the file dividers are attached to the cover.

FIGS. 4A, 4B, and 4C shows an embodiment of multiple components which can be used to manufacture a ring binder with a loose paper storage system. FIG. 4A shows a cover, FIG. 4B shows outer dividers and FIG. 4C shows inner dividers.

FIG. 5 shows an embodiment of an organizer for use with an object such as a pad of bound paper and including a loose paper storage system on the front cover.

FIG. 6 shows an embodiment of a specialty divider usable with a loose paper storage system.

### DETAILED DESCRIPTION OF PREFERRED EMBODIMENT(S)

A loose paper storage system will be discussed for attachment to an organizer. This storage system is different from the holding mechanisms already present in organizers because it is used to store loose paper in conjunction with the organizer as opposed to the special paper or objects organizers are already arranged to hold. The term “loose paper” is used herein to mean papers which are not adapted for storage into the type of holding mechanism already present in the organizer. This may be because the holding mechanism requires the pages to be adapted for insertion into that mechanism or because the holding mechanism is configured to hold an object instead of paper. An example of a loose paper is a paper which is to be stored in conjunction with a three-ring binder, but is not three-hole punched. It should be recognized that holding mechanisms, as discussed herein, can be those that can have sheets added to them (e.g. a three-ring mechanism), can be those which come with paper already attached and cannot be added to (e.g. a spiral or other binding, or a pad or tablet), or can be those adapted to hold objects other than paper (e.g., a pad holder or cover for a PDA). In the case of the latter types of holding mechanisms, all papers not in the mechanism are loose as the mechanism is not configured to have papers added. It is also important to note that a loose paper may be configured to fit in a different type of holding mechanism than the one used and still be loose. For instance, a three-hole punched paper may be a loose paper when stored in conjunction with a two-ring binder. Further, a loose paper could be configured for attachment to the holding mechanism, but is simply not attached thereto for whatever reason. This definition is not intended to limit the terms in this application as would be understood by one of ordinary skill in the art, but to provide an indication of how the terms used herein interact with each other.

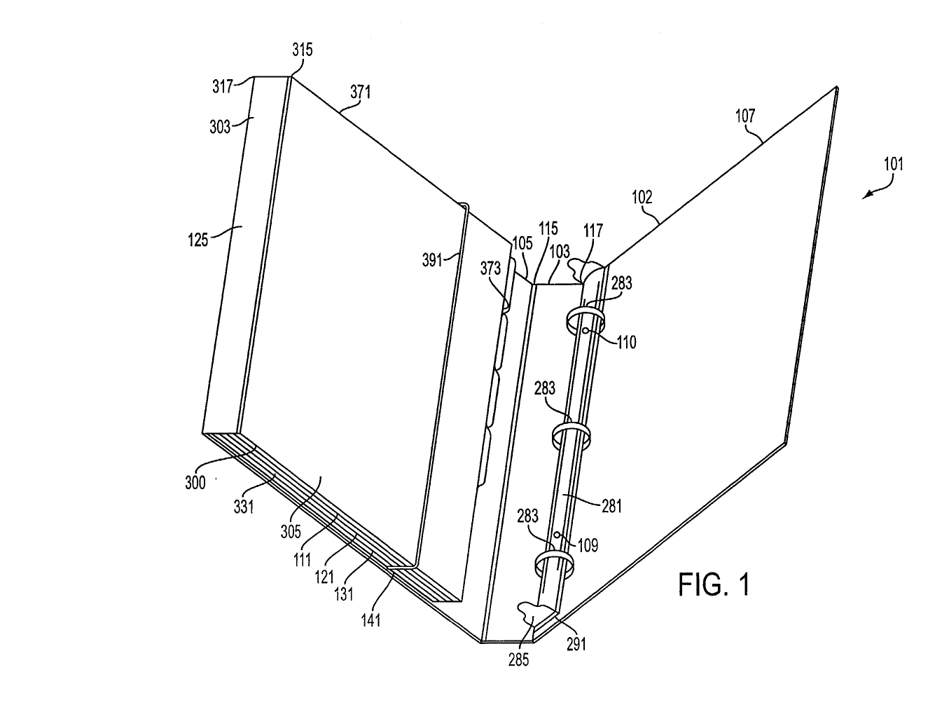

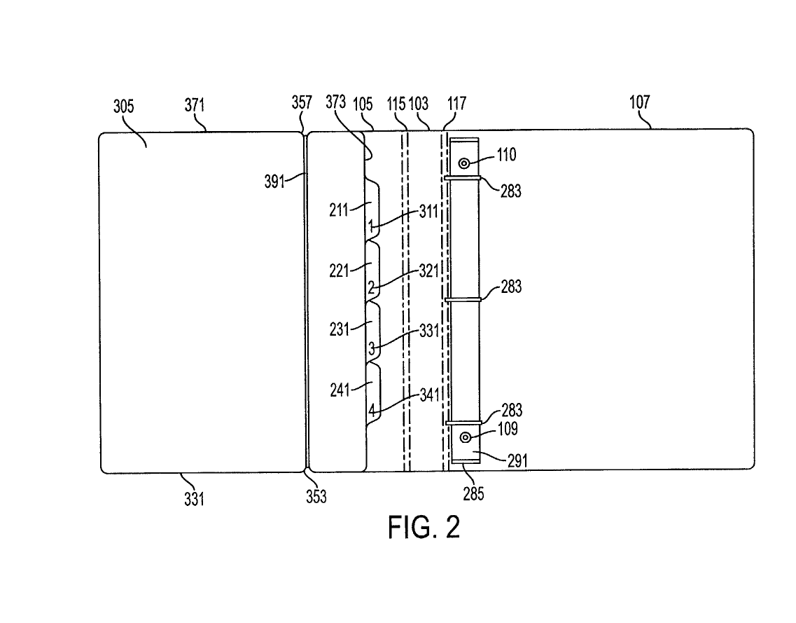

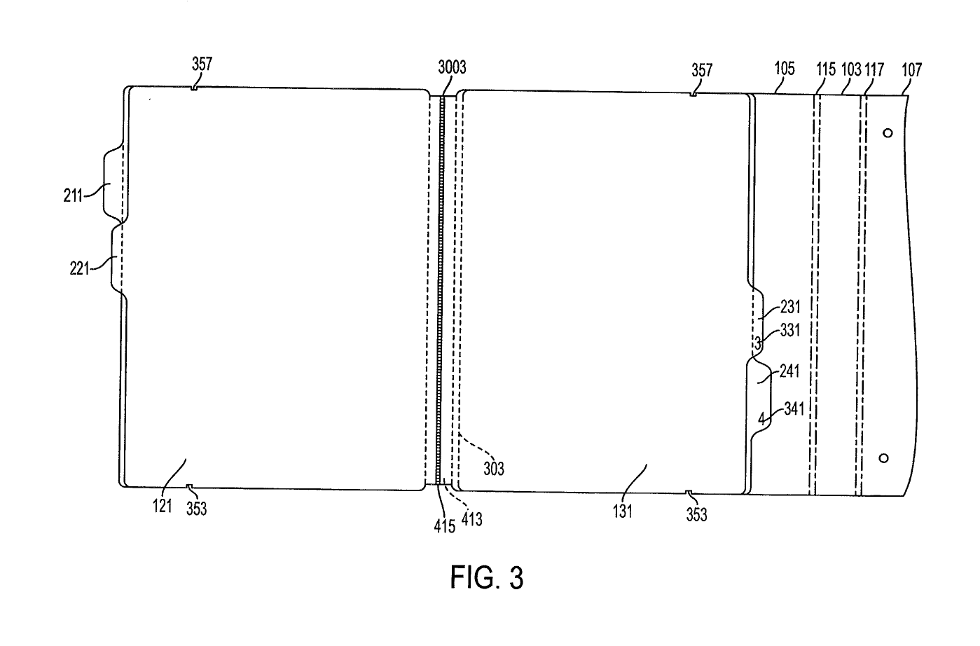

FIGS. 1 through 3 will be discussed simultaneously. FIG. 1 shows an inner perspective view of an embodiment of a binder (101) with a loose paper storage system (300). FIG. 2 shows the same embodiment as viewed straight on with the loose paper storage system (300) closed. FIG. 3 shows an embodiment of a loose paper storage system (300) open. The binder is one type of organizer and in an embodiment is composed of a binder cover (102), a sheet holding mechanism (291 ) and a loose paper storage system (300). The binder cover (102) provides cover for the papers or materials included within the binder (101). The binder cover (102) is composed of a spine (103), a front cover (105), and a rear cover (107) and is generally manufactured from, but is not limited to, papers, plastics, chipboards, metals, cardboards, vinyls, or any combination of such materials. The spine (103) generally defines the width of the binder (101) and the amount of papers it can hold within it. The front cover (105) and rear cover (107) are connected to the spine by hinges (115) and (117) respectively. These hinges (115) and (117) allow for the covers to be swung away from the papers to access the papers secured in the sheet holding mechanism (291) or otherwise secured inside the binder (101). The hinges are often simply reinforced strips of the material used in the construction of the binder cover (102) and/or are score line(s) in the binder cover (102) allowing for easier bending at that point. However, in other embodiments, hinging mechanisms may be used. The sheet holding mechanism (291) is attached to the inside of the cover. The presence of this sheet holding mechanism (291) effectively defines the inside and outside of the binder (101). Although the covers can often bend in either direction freely relative to the spine (103), the covers are generally intended to cover the pages contained in the sheet holding mechanism (291). The sheet holding mechanism (291) may be any type of sheet holding mechanism but will often comprise a ring mechanism as is depicted in FIGS. 1 and 2. Ring mechanisms come in a wide variety of shapes and sizes, but generally have a similar structure. A ring holding mechanism includes a rib (281) generally constructed of a rigid material (such as metal) which is secured to the binder cover (102) through the use of rivets (109) and (110) which pierce the binder cover (102). The rib (281) has a number of rings (283), usually three although ring binders may have more or less as is understood by one of ordinary skill in the art, which extend away from the rib (281). The three-ring binder is a particular type of binder having a three-ring element. These rings (283) may be circular, oval, D shaped or of any other shape as would be known to one of skill in the art. The rings (283) are designed to secure sheets of materials, usually papers but other objects adapted for ring storage are known to those of ordinary skill in the art, by the placement of the rings (283) through holes in the sheet to be inserted within the binder (101). The rings (283) generally separate at a point in their diameter to allow placement of objects on the rings (283) by running the structure of the rings (283) through holes in the object. The rings (283) also generally include a biasing mechanism (not shown) for holding the rings (283) in a closed and/or open position and a mechanism (285) for opening and/or closing the rings (283) to allow for hole punched papers to be added to the rings (283), or to allow for the rings (283) to secure the hole-punched papers thereto. A ring mechanism is merely one of a plethora of sheet holding mechanisms (291). The invention herein can easily be adapted to use any sheet holding mechanism (291) that would be desirable in a binder (101) or other organizer (whether allowing papers to be added thereto or not) as would be understood by one of ordinary skill in the art. Although in FIG. 1 the sheet holding mechanism (291) is shown attached to the back cover (107), many binders place the sheet holding mechanism (241) on the spine (103). Such a design for the binder (101) may also be used in an embodiment.

FIGS. 1 and 2 further show a loose paper storage system (300) attached to the front cover (105) of the binder (101). The loose paper storage system (300) comprises a loose paper storage system cover (305), a loose paper storage system spine (303), a plurality of file dividers (111), (121), (131), and (141), and a securement mechanism (391). The loose paper storage system (300) is designed to be up against the inside front cover of the binder when in the closed position 20 as shown. The loose paper storage system cover (305) is attached to the loose paper storage system spine (303) by hinge (315) which is in turn attached to the front cover at the outer edge (125) by hinge (317). In another embodiment, the loose paper storage system spine (303) could be attached to a different edge or portion of the front cover (105), and in still another embodiment could be attached to any edge or portion of the back cover (107). In operation, the loose paper storage system cover (305) is designed to be spaced from the inside of the front cover (105) while in a roughly parallel and onset position when in the closed position. When opened, the loose paper storage system cover (305) rotates away from the front cover (105) to extend from the outer edge (125) of the front cover (105) in what is often a coplanar relation.

Also included in the loose paper storage system are a plurality of dividers (111), (121), (131), and (141). These are designed to allow for the organization of papers that are to be placed into a loose paper storage system (300). When the loose paper storage system cover (305) is closed, the dividers (111), (121), (131), and (141) lie parallel to the cover (305) and the front cover (105). When opened, the spaces between the dividers can be accessed for the placement of loose papers or other objects for storage therein. When the cover is closed again, pressure may be placed on the enclosed papers and dividers to help secure them. The dividers can therefore be thought of as defining a plurality of filing spaces between neighboring dividers, or the dividers and either the front cover (105) or the loose paper storage system cover (305). In a preferred embodiment, these filing spaces have a noticeable width allowing larger numbers of papers to be placed in each one of them than may be placed in binder pockets. They may also be thought of as a series of fanned dividers defining a file. In FIG. 3 the loose paper storage system (300) is shown in an open position with the filing space between dividers (121) and (131) visible. This space is visible because the loose paper storage system cover (300) has been rotated away from the front cover (105) and dividers (111) and (121) have been onset to the loose paper storage system cover (305) while dividers (131) and (141) are onset to the front cover (105). Papers could be placed in this space when in this position. One of ordinary skill in the art would understand that similar filing spaces could be accessed if different dividers were onset to the front cover (105) and/or loose paper storage system cover (305).

To further secure the papers within the loose paper storage system (300), there is included a securement mechanism (391) to hold the loose paper storage system (300) in a closed position. In FIGS. 1 and 2, the securement mechanism (391) comprises an elastic band or ribbon attached to the front cover on the front cover through holes (393) and (395) and then wrapped around the dividers (111), (121), (131), and (141) and the file system cover (305). Generally, the elastic band will have a knot or other object on the end to prevent the end from passing through holes (393) and (395) although it could also be an unbroken circular band in another embodiment. The elastic band compresses the file system cover (305) and the file dividers into the front cover (105) of the binder (101) increasing the pressure exerted on items placed in the filing spaces between the dividers and increasing the friction on them to maintain them within the filing spaces. It also prevents unintended opening of the loose paper storage system (300). In the embodiment shown in FIGS. 1 and 2, the securement mechanism (391) also helps to secure items in the dividers by its positioning. The securement mechanism (391) passes over the top (371) and bottom (331) edges of the dividers as well as the loose paper storage system cover (305). Since the securement mechanism (391) passes over the top and bottom edges (371) and (331), if normal sized sheets are placed within the dividers (111), (121), (131), and (141), the sheets will be retained from falling past these edges by the securement mechanism (391). Pages are secured from falling out of the inside edge (373) because it faces in toward the spine (103) when the loose paper storage system (300) and binder (101) are closed and is generally blocked off by the spine (103). Further, binders are generally carried or stored in an upright position with the top edge (371) upward, further securing papers. In another embodiment, the securement mechanism (391) could attach to any part or parts of the binder (101) and need not pass over any part of the top (371) and/or bottom (331) edges. It will be understood by those skilled in the art that the securement mechanism (391) could hold the loose paper storage system cover (305) in a closed and/or open position.

In another embodiment of the invention, the dividers (111), (121), (131), and (141) are connected to each other on the top edge (371) and/or bottom edge (331) by a flexible and/or accordion edge. This provides for increased protection for objects placed in the filing spaces between the dividers from falling out, but would usually not allow the dividers (111), (121), (131), and/or (141) to be swung open as wide as is shown in FIG. 3.

As is visible best from FIG. 2, there are tabs (211), (221), (231) and (241) attached to each of the dividers (111), (121), (131), and (141). These allow for easy organization of loose papers or other items placed in the loose paper storage system (300). The tabs shown each include a number (311), (321), (331), and (341) or other indicator for indicating which divider is which. In another embodiment of the invention, each tab may include a small window, recess, or writing area for allowing a user to place a label for personalizing the name of each divider (and presumably the associated space). Such types of tabs are well understood by those of ordinary skill in the art. These indicators preferably match indicators on dividers available for placement on the rings, but such is by no means necessary. In such an embodiment, the filing spaces in the loose paper storage system can correspond to groups of papers filed on the rings. Therefore loose papers placed in the loose paper storage system (300) can be easily organized in conjunction with, and to correspond to, papers organized on the rings allowing for organized storage of loose papers in a highly effective manner. Further, if the two indicators are similar, easy access to those loose papers is also available.

FIG. 2 and 3 also show small cutouts (357) and (353) in the file system cover (305). These cutouts (357) and (353) allow the elastic band used as the securement mechanism (391) to be securely held in a particular position. In the depicted embodiment, this is the closed configuration and the cutouts (357) and (353) have been placed so as to be in generally linear arrangement with the holes (393) and (395). This arrangement allows the elastic band to be at a minimum extension when wrapped around the loose paper storage system cover (305) and to prevent the band from slipping off of the loose paper storage system cover (305) when the organizer is jostled.

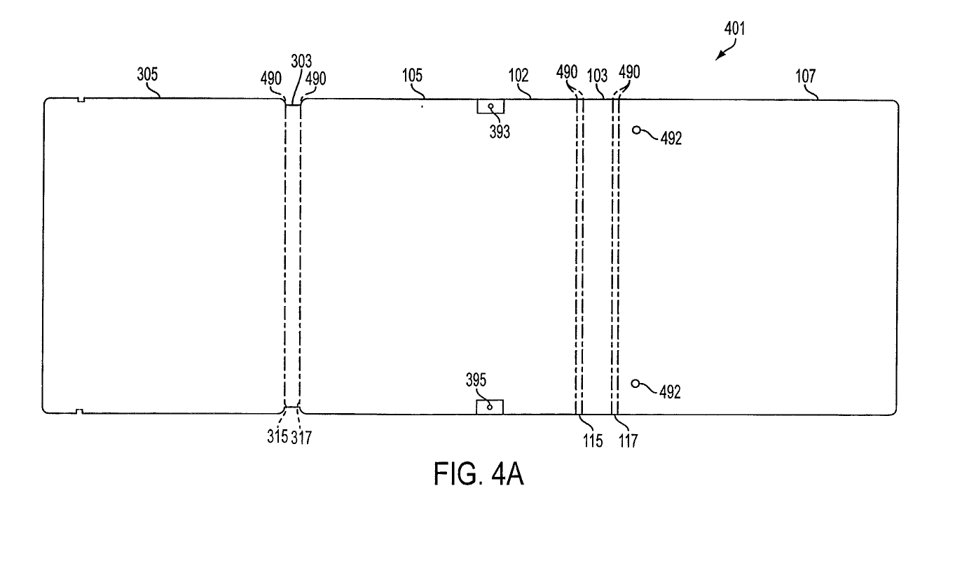

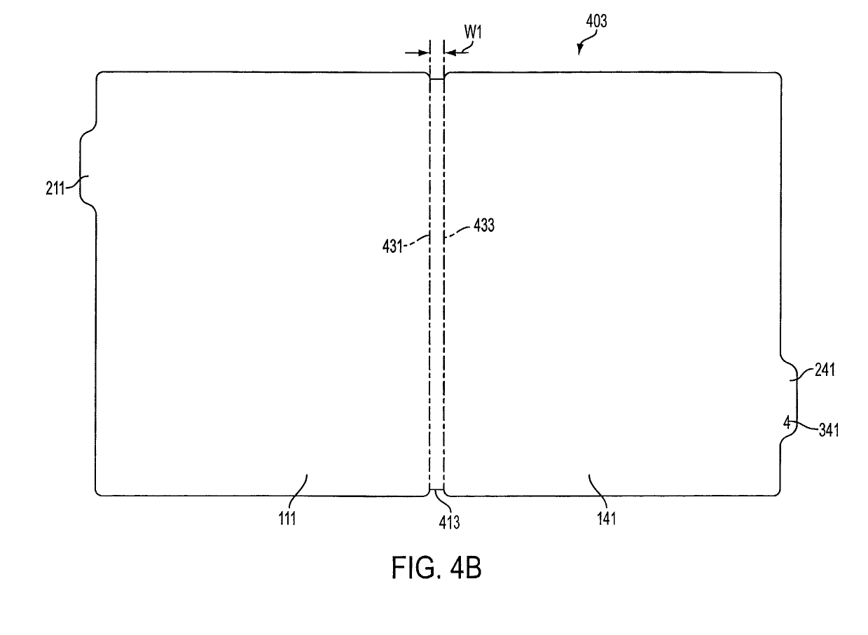

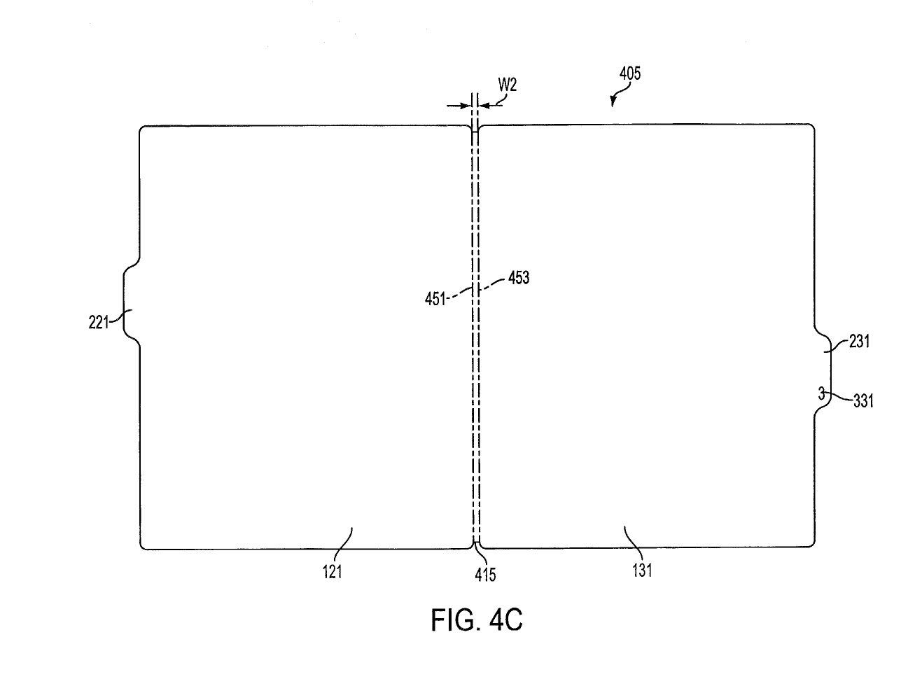

FIGS. 4A, 4B, and 4C provide for a series of sheets (401), (403), and (405) which can be used to construct a binder or other organizer including a loose paper storage system such as that in FIGS 1 and 2. Sheets (401), (403), and (405) can be manufactured by methods including, but not limited to, flat pattern die cutting, roller type die cutting, or any other method for cutting materials and can be manufactured of any material including, but not limited to, plastics, papers, cardboards, chipboards, metals, vinyls, or any combination of the above.

FIG. 4A provides a sheet (401) designed to form a binder cover (102) or other organizer cover with an attached loose paper storage system cover (305). The sheet (401) is a single piece that is then scored, formed or otherwise bent along score lines (490) to allow for the creation of the hinges (117), (115), (317), (315) and the spines (303) and (103). The sheet can also have holes (492) punched for the attachment of the sheet holding mechanism (291) and/or holes (393) and (305) for the securement mechanism (391). One of ordinary skill in the art would see that if holes (492) were replaced by a flap or other holding mechanism secured to the back cover sheet (401) then could be used to create an organizer for holding different objects.

FIG. 4B provides for a single sheet (403) that can be used to form the outer dividers (111) and (141). The sheet is designed so as to have the two dividers (111) and (141) arranged so that their under edges (431) and (433) are connected by a channel (413). The sheet therefore shows on the visible side one divider (111) having a front side down, while the other (141) has a front side up. The channel has a particular width (W1) also shown in FIG. 4B. Generally the width (W1) will be about the same width, or slightly less than, the width of the loose paper storage system spine (303).

FIG. 4C provides a single sheet (405) which can make the two interior dividers (121) and (131). Again, the sheet is designed so as to have the two dividers (121) and (131) arranged so that their under edges (451) and (453) are connected by a channel (415). The sheet again shows on the visible side one divider (121) having a front side down while the other (131) has the front side up. This channel has a width (W2) such that W2 is less than or equal to W1. To assemble the loose paper storage system, the sheet (405) (the interior dividers) can be placed on the sheet (403) (the exterior dividers) with channel (415) placed over channel (413) and generally centered or otherwise arranged thereon. Both sheets (405) and (403) can then be placed on the sheet (401) (the cover) with the channel (413) on the loose paper storage system spine (303), again generally centered or otherwise arranged thereon. The sheets can then be attached to each other through the overlapping channels. Such an attachment is shown in FIG. 3 with a line of attachment at (303) through each of the channels. This attachment can be accomplished through methods such as, but not limited to, adhesives, sonic welding, or thermal welding. This forms a structure such as that shown in FIGS. 1-3 when the spine is then folded over and all the dividers are bent upwards to form a U-shape with their appropriate channel as is apparent from FIGS. 1-3. A securement mechanism, such as an elastic band, can then be threaded through holes (393) and (395), and secured on the outside of the binder such as by, but not limited to, a metal end to the band which is rotated so as not to fit through the holes (393) and (395), or any other manner as would be understood by one of ordinary skill in the art.

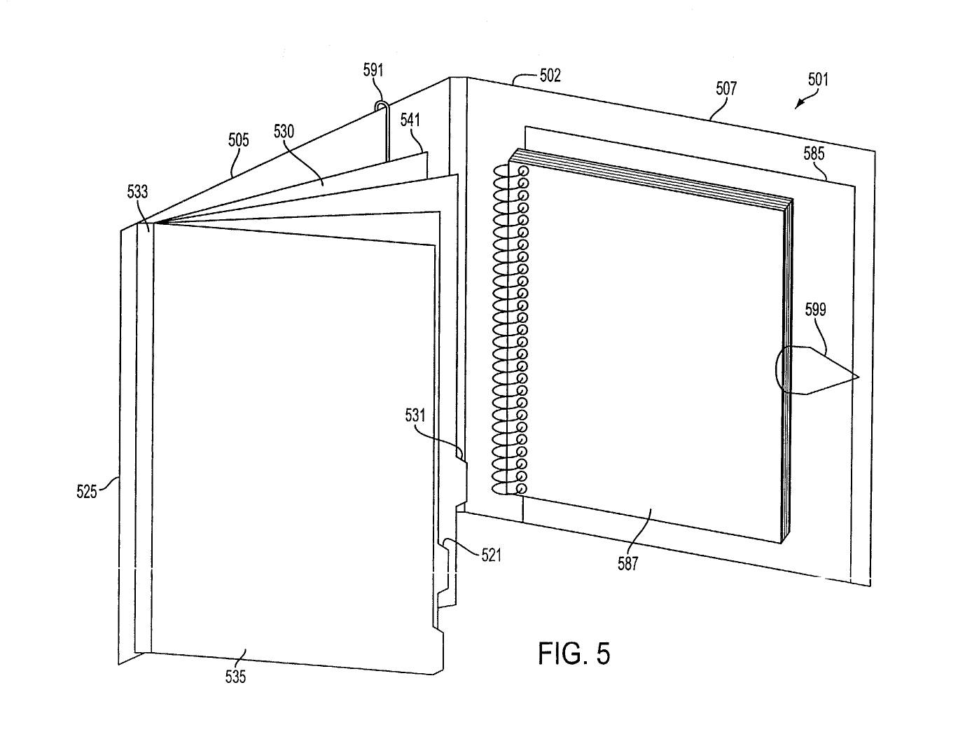

One of ordinary skill in the art, examining FIGS. 1-3 would see that the loose paper storage system (300) could be attached to any type of known organizer with covers. The sheet holding mechanism (281) on the binder could be replaced with a holding mechanism for any object in an alternative organizer. FIG. 5 shows an alternative embodiment of an organizer with a loose paper storage system. In FIG. 5 there is shown an organizer (501) which comprises a cover (502) which has a holding mechanism (585) (such as, but not limited to, a pocket flap) attached to the back cover (507) for attachment to the rear cover of an object (587). This object may be, but is not limited to, a pad of bound paper such as, but not limited to, a spiral notebook, a tablet or other glued pad, a bound document, or any combination of the above; or any other device such as, but not limited to, a calculator, a cellular telephone, a Personal Digital Assistant (PDA), a laptop computer, or an electronic data pad. As will be understood, the cover (502) may be designed to protect the object (587) attached to the holding mechanism (585). The embodiment of FIG. 5 provides a pad of bound paper, particularly a spiral notebook, as the object (587). The holding mechanism (585) is a pocket flap for the insertion of the rear cover of the pad of bound paper in FIG. 5. One of ordinary skill in the art would recognize, however, that alternative holding mechanisms (585) are desirable for holding alternative objects; for instance, a specially shaped plastic structure could be used to secure a PDA. The organizer provides for a front cover (505) which will fold over and cover the object (587). Mounted upon the front cover (505) in a manner similar to that of FIGS. 1-3 is a loose paper storage system (530). The loose paper storage system cover (535) is attached to the loose paper storage system spine (533) but that is in turn not attached to the outer edge (525) of the cover (505). Instead the loose paper storage system spine (533) is mounted a small distance away from the edge (525) and is inside the organizer. This design allows for the loose paper storage system cover (535) to easily be made of a different material than the organizer cover (505). The loose paper storage system (530), however, has a similar design to the loose paper storage system (300) with a plurality of file dividers (521), (531), and (541) arranged so as to be between the loose paper storage system cover (535) and the front cover (505). FIG. 5 also shows a securement mechanism (591) which is depicted as an elastic band for holding the loose paper storage system (530) closed and against the cover. There is also shown an organizer latch (599) (in this case, a small elastic circle) with a corresponding tab (not visible, on the front cover (505)) which may be present to latch the organizer (501) in the closed position. Like those embodiments discussed above with regards to FIGS. 1-4, the loose paper storage system (530) could be attached to any edge or any portion of any cover in alternative embodiments and could have any of the structure discussed previously.

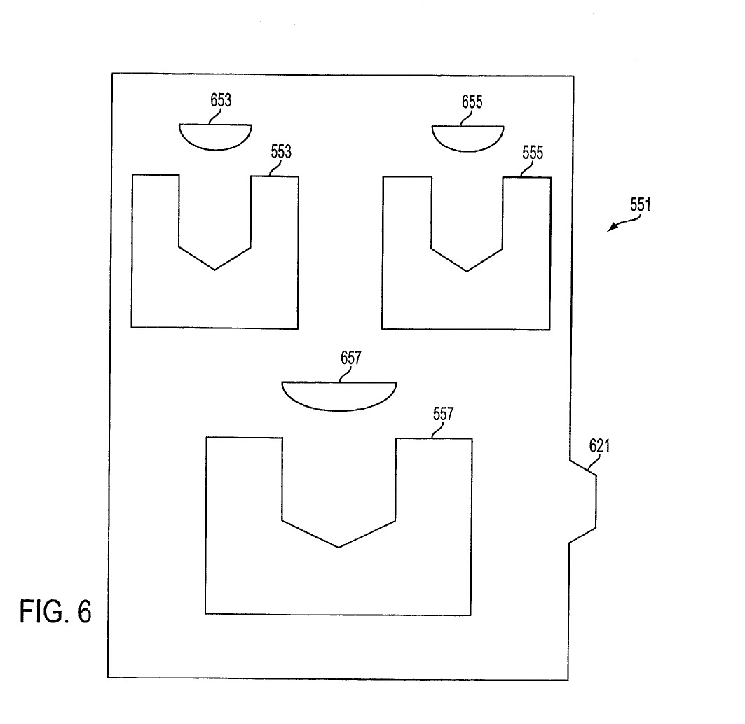

FIG. 6 shows a specialty divider (551) which may be used in a loose paper storage system in place of a regular divider. This divider has a tab (621) (although a tab is not necessary) and is specially configured to hold smaller, generally specifically shaped items, securely within the loose paper storage system (530). In particular, specialty divider (551) includes 3 pockets (553), (555), and (557) attached thereto which are specifically sized to hold computer media such as floppy disks ((553) and (555)), and a Compact Disk (CD) or Digital Video Disk (DVD) (557). Each of these pockets also includes a flap (653), (655), and (657) associated therewith to help hold the media in place (e.g. by hooking the flap over the top of the media). Specialty divider (551) is one of a plethora of specialty dividers which could be included inside a loose paper storage system designed primarily to hold papers, or with any type of additional storage system to hold virtually anything. In addition, these specialty dividers could include built-in devices (e.g. a calculator) or could be designed to provide special functions such as being a zippered pocket for holding small items. This divider may be used in conjunction with any of the loose paper storage systems described herein. One of skill in the art would recognize that almost any type of divider can be included for virtually any purpose whatsoever. These would generally include anything useful in a school or office setting.

In yet another embodiment, a loose paper storage system, such as those described herein, could be attached to the cover of any organizer, to hold loose paper in conjunction therewith. In an embodiment, the organizer could be a cover for a writing tablet, such as those commonly referred to as resume folders or binders. Alternatively, any type of organizers which can hold papers specifically configured for a holding mechanism, can also include a loose paper storage system such as those described above. In a still further embodiment, the sheet holding mechanism could be dispensed with entirely and a cover (e.g. such as a folder) or protective cover could include the loose paper storage system described herein.

One of ordinary skill in the art would recognize that although the loose paper storage systems shown herein have a particular number of dividers and components, that number is by no means required and any number of dividers or elements may be used in the loose paper storage system while remaining within the scope of this invention. In another embodiment, the loose paper storage system could be aligned so that it opens in any direction relative to any cover. For instance, the tops of the dividers (the edges with the tabs) of loose paper storage system (300) could be adjacent to the outer edge (125) of the cover, or the top edge (371) of the cover, for example. In such embodiments, the loose paper storage system (300) could open in a different direction. This is particularly true if the loose paper storage system spine (303) was attached to the bottom edge (331) of the binder (101). In still another embodiment, the loose paper storage system could be configured for removable attachment to the cover and could be separable from the cover.

While the invention has been disclosed in connection with certain preferred embodiments, other embodiments should be understood to be encompassed in the present disclosure as would be understood by those of ordinary skill in the art.

1. An organizer comprising:
a organizer cover including, a front cover and a back cover and having an inside, and an outside;
a sheet holding mechanism designed to secure items thereto which have been prepared for placement on said sheet holding mechanism, said sheets holding mechanism being inside and attached to said organizer; and
a loose paper storage system, attached to at least one of said front cover and said back cover and including a loose paper storage system cover, and at least one divider.

2. The organizer of claim 1 wherein said organizer comprises a binder.

3. The organizer of claim 1 wherein said sheet holding mechanism comprises a ring mechanism.

4. The organizer of claim 3 wherein said ring mechanism comprises a three-ring mechanism.

5. The organizer of claim 1 wherein said divider includes a tab.

6. The organizer of claim 5 wherein said tab includes an identifier.

7. The organizer of claim 1 wherein said loose paper storage system further includes a securement mechanism.

8. The organizer of claim 7 wherein said securement mechanism passes over at least one of a top edge and a bottom edge of said loose paper storage system.

9. The organizer of claim 7 wherein said securement mechanism comprises an elastic band.

10. The organizer of claim 1 wherein said loose paper storage system is attached to an edge of said front cover.

11. The organizer of claim 1 wherein said loose paper storage system is attached to an edge of said back cover.

12. The organizer of claim 1 wherein said at least one divider includes at least one specialized divider.

13. The organizer of claim 1 wherein said at least one specialized divider is configured to hold computer media.

14. A method for constructing an organizer, the method comprising:
providing a first sheet of material, said first sheet including a front cover, a rear cover, a loose paper storage system cover, and at least two hinges;
providing a second sheet of material, said second sheet of material having at least two dividers and a channel separating them;
providing a third sheet of material, said third sheet of material having at least two dividers and a channel separating them;
placing said channel of said third sheet on said channel of said second sheet and attaching said channels to each other and to said first sheet;
attaching to said first sheet a mechanism configured to hold an object; and
deforming said first, second, and third sheets, into an organizer with all said dividers positioned between said front cover and said loose paper storage system cover, and said mechanism positioned inside said front cover and said rear cover.

15. An organizer comprising:
a cover including, a front cover and a back cover and having an inside, and an outside;
a holding mechanism attached inside said cover for holding an object therein; and
a loose paper storage system, attached to said inside of said cover on at least one of said front cover and said back cover and including a loose paper storage system cover, and at least one divider.

16. The organizer of claim 15 wherein said object includes a pad of bound paper.

17. The organizer of claim 16 wherein said pad of bound paper comprises a spiral notebook.

18. The organizer of claim 16 wherein said pad of bound paper comprises a tablet.

19. The organizer of claim 15 wherein said divider includes a tab.

20. The organizer of claim 19 wherein said tab includes an identifier.

21. The organizer of claim 15 wherein said loose paper storage system further includes a securement mechanism.

22. The organizer of claim 21 wherein said securement mechanism comprises an elastic band.

23. The organizer of claim 15 wherein said loose paper storage system is attached to an edge of said front cover.

24. The organizer of claim 15 wherein said loose paper storage system is attached to an edge of said back cover.

25. The organizer of claim 15 wherein said at least one divider includes at least one specialized divider.

26. The organizer of claim 15 wherein said at least one specialized divider is configured to hold computer media.

27. The organizer of claim 15 wherein said cover is configured to protect said object.

28. The organizer of claim 15 wherein said object includes at least one of a cellular telephone, a Personal Digital Assistant (PDA), a laptop computer, and an electronic data pad.
